(19) United States
(12) Patent Application Publication
(10) Pub. No.: US 2018/0244968 A1
(43) Pub. Date: Aug. 30, 2018

(54) Decorative Material, Particularly Artificial Snow, And A Method For Producing Same

(71) Applicant: Clariant International Ltd., Muttenz (CH)

(72) Inventors: Reinhard VYBIRAL, Burgkirchen (DE); Christian PETERSHOFER, Burgkirchen (DE)

(73) Assignee: Clariant International Ltd., Muttenz (CH)

(21) Appl. No.: 15/551,028

(22) PCT Filed: Jan. 19, 2016
(86) PCT No.: PCT/EP2016/050938

§ 371 Date: Aug. 14, 2017

(30) Foreign Application Priority Data
Feb. 16, 2015 (DE) 10 2015 001 915.5

(51) Int. Cl. C09K 3/24; C08J 3/12

(52) U.S. Cl. CPC C09K 3/24; C08J 2371/02; C08J 3/122

(57) ABSTRACT

The invention relates to a decorative material which comprises a polyethylene glycol having a number average molecular weight in the range of 1,500 to 35,000 g/mol, in the form of solid, flake-like or powder-like particles with a bulk density of between 0.3 and 1.1 g/cm³ and a particle size of between 1 μm and 20 mm; and to a method for producing same.

This invention relates to a decorative material, especially to artificial snow, which can be used for general and seasonal decoration. The invention also relates to a process for producing decorative material, especially artificial snow, from polyethylene glycol. The invention further relates to the use of polyethylene glycol for production of decorative material, especially artificial snow.

Decorative material, especially artificial snow, has various fields of use which include increasing the attractiveness of, for example, display windows, exhibition rooms, trade fair stands, restaurant window displays, commercial photography and film and the like. Artificial snow can be used for the seasonal decoration of homes and businesses, and as a substitute for real snow in theater productions, film sets and the like.

Artificial snow is preferably similar to natural snow in texture and color, but this is difficult to achieve.

US 2005/0126693 teaches a decorative artificial snow product and a method for production thereof. The artificial snow product comprises a white-pigmented silicone rubber shaped in the form of snowfields.

US 2011/0065841 teaches a process for producing artificial snow by extruding a mixture of starch, polyvinyl alcohol, hydrogenated soya flakes and talc, and distributing it in the form of flakes.

Artificial snow or decorative material is often used at sites that are accessible to the public, and should therefore not constitute any health risk. The decorative material is additionally to be noncombustible.

The invention provides a decorative material comprising a polyethylene glycol having a number-average molecular weight in the range from 1500 to 35 000 g/mol in the form of particles that are in solid form or in the form of flakes or powder and have a bulk density of 0.3 to 1.1 g/cm³ and a particle size of 1 μm to 20 mm.

The invention further provides a process for producing decorative material, especially artificial snow, by converting liquid polyethylene glycol to a solid form, by converting the liquid polyethylene glycol to flakes on cooled belts or rollers and then comminuting them to a particle size of 1 μm to 20 mm.

The invention further provides for the use of polyethylene glycol having a number-average molecular weight in the range from 1500 to 35 000 g/mol in the form of particles that are in solid form or in the form of flakes or powder and have a bulk density of 0.3 to 1.1 g/cm³ and a particle size of 1 μm to 20 mm as decorative material, especially artificial snow.

Flake-like particles have, as a preferred embodiment of the invention, a particle size of 0.1 to 20 mm, preferably of 0.4 to 10 mm. Particles in powder form have, as a preferred embodiment of the invention, a particle size of 1 to 1000 μm, preferably of 5 to 700 μm.

In a preferred embodiment, the bulk density of the decorative material of the invention is between 0.3 and 0.8 and especially between 0.4 and 0.7 g/cm³.

For the execution as a powder, the melt can be processed in a cold spraying system to give spray powder. Spray powders preferably contain up to 15% by weight of powder particles having a size of <90 μm, 20% to 45% by weight of powder particles having a size of 90 to 200 μm, and 35% to 70% by weight of powder particles having a size of >200 μm. Spray powders of this kind preferably have a bulk density of 0.43 to 0.72 g/cm³.

However, it is also possible to produce ground powders by a grinding process in a grinding system. In one embodiment, ground powders preferably contain 1% to 30% by weight of powder particles having a size of <90 μm, 10% to 30% by weight of powder particles having a size of 90 to 200 μm, and 50% to 75% by weight of powder particles having a size of >200 μm. Ground powders of this kind preferably have a bulk density of 0.5 to 0.7 g/cm³. In one embodiment, fine ground powders contain preferably 75% to 95% of powder particles having a size of <90 μm, 5% to 25% by weight of powder particles having a size of 90 to 200 μm, and 0% to 5% by weight of powder particles having a size of >200 μm. Such fine ground powders preferably have a bulk density of 0.45 to 0.55 g/cm³.

The particle size is measured by means of suitable particle analyzers. The choice of the suitable particle analyzer depends on the particle size to be measured. Particle sizes in the range from 1 μm to 1 mm are preferably measured by means of light scattering. A suitable particle analyzer that utilizes light scattering is the Retsch Crystalsizer instrument. Particle sizes in the range from 1 to 20 mm are preferably determined mechanically by sieve analysis.

In a preferred embodiment, the bulk density of the decorative material of the invention is between 0.3 and 0.8 and especially between 0.4 and 0.7 g/cm³.

In a preferred embodiment, the artificial snow of the invention or the decorative material of the invention, especially artificial snow, comprises a polyethylene glycol having a number-average molecular weight of 2000 to 30 000 and especially 4000 to 25 000 g/mol.

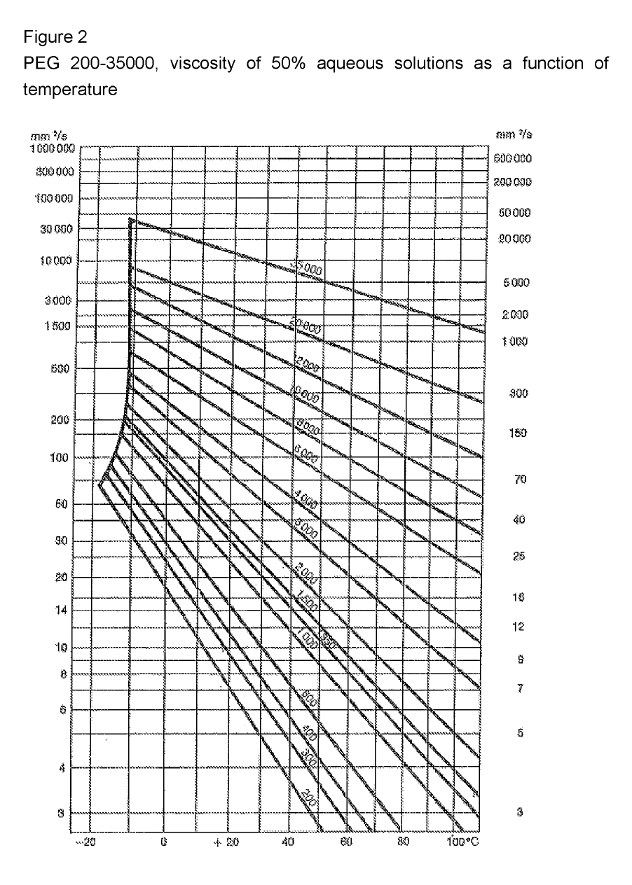

The molecular weight is determined by means of determination of the viscosity of a 50% aqueous solution of the polyethylene glycol at 20° C. by a rotary viscometer measurement (ISO 6388). The correlation of the number average molecular weight with measured viscosity can be inferred from FIG. 2.

The melting point of the polyethylene glycols used is preferably 35 to 65° C., especially 40 to 60° C.

It is possible to add stabilizers such as BHA (butylhydroxyanisole) or BHT (butylhydroxytoluene), each in food quality, to the polyethylene glycol. Polyethylene glycol, which is already very storage-stable in itself, can be made even more storable through the addition of these stabilizers. The proportion of added stabilizer may be 0.01% by weight to 0.10% by weight, based on the weight of the decorative material.

In a further embodiment, it is possible to add various dyes or odorants to the polyethylene glycol, and hence, for example, to associate the field of use of decoration with the further field of use of fragrancing of, for example, commercial spaces, exhibition spaces or else private spaces.

By addition of suitable dyes in a concentration of 0.01%-2% by weight based on the weight of the decorative material, especially artificial snow, it is possible to achieve additional color effects.

The decorative material of the invention, especially artificial snow, is environmentally friendly and nontoxic, and overcomes problems with other artificial snow/decorative material products which contain materials that are harmful to health, toxic or environmentally damaging.

The decorative material of the invention, especially artificial snow, can be produced as follows.

Proceeding from a suitable raw material, preferably a polyalkylene glycol having up to 6 carbon atoms, especially monoethylene glycol or diethylene glycol, a polyethylene glycol having molar mass 1500 to 35 000 g/mol is produced via the reaction with ethylene oxide in suitable ethoxylation reactors. This polyethylene glycol is supplied as a melt to a plant for production of flake-like particles. In this plant, the melt is cooled on cooled belts or rollers to such an extent that the polyethylene glycol solidifies. In order to obtain the particle size of 1 μm to 20 mm, the product is then sent to a comminution apparatus. After the comminution, the product is dispensed into suitable containers.

The artificial snow produced or the decorative material in general, as a result of the production process, has a characteristic and very attractive visual effect. The flake-like particles sparkle under light and the pure white or optionally colored appearance can be employed for the desired effects.

The artificial snow of the invention is suitable for use for seasonal decoration of homes and businesses, and as a substitute for real snow in theater productions, film sets and the like. The artificial snow of the invention can also be used in the production of advertising and other commercial artwork. The decorative material of the invention in general is suitable for use for increasing the attractiveness of, for example, window displays, exhibition spaces, trade fair stands, restaurant window displays, commercial photography and film and the like.

### EXAMPLE

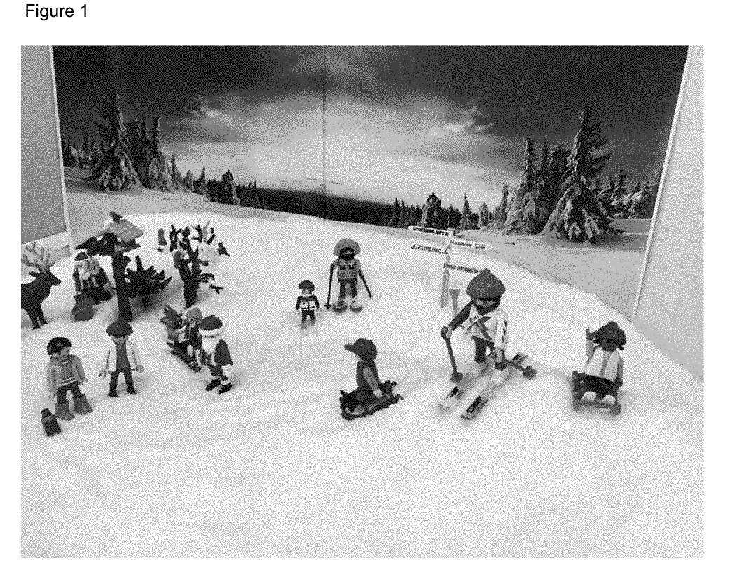

PEG flakes having number-average molecular weight 12 000 g/mol, determined from a viscosity of the 50% aqueous solution of about 1300 mPas at 20° C. (measured by rotary viscometer, ISO 6388), a melting point of about 56° C. and a particle size of 0.2 mm to 10 mm was arranged together with further decorative material to give a winter landscape. This gives the impression of snow, as apparent in FIG. 1.

1. A decorative material comprising a polyethylene glycol having a number-average molecular weight in the range from 1500 to 35 000 g/mol in the form of particles that are in solid form or in the form of flakes or powder and have a bulk density of 0.3 to 1.1 g/cm³ and a particle size of 1 μm to 20 mm.

2. The decorative material as claimed in claim 1, in which the number-average molecular weight of the polyethylene glycol is between 2000 and 30 000 g/mol.

3. The decorative material as claimed in claim 1, in which the number-average molecular weight of the polyethylene glycol is between 4000 and 25 000 g/mol.

4. The decorative material as claimed in claim 1, wherein the melting point of the polyethylene glycol is 35 to 65° C.

5. The decorative material as claimed in claim 1, wherein the melting point of the polyethylene glycol is 40 to 60° C.

6. The decorative material as claimed in claim 1, wherein butylhydroxyanisole or butylhydroxytoluene, each in food quality, are additionally added.

7. The decorative material as claimed in claim 1, wherein one or more dyes in a concentration of 0.01%-2% by weight, based on the weight of the decorative material, are additionally present.

8. The decorative material as claimed in claim 1, wherein one or more odorants are additionally present in an effective concentration.

9. The decorative material as claimed in claim 1, in the form of flakes having a particle size of 0.1 to 20 mm.

10. The decorative material as claimed in claim 1, in the form of powder having a particle size of 1 to 1000 μm.

11. An artificial snow comprising the polyethylene glycol as claimed in claim 1.

12. A process for producing a decorative material, comprising the steps of converting liquid polyethylene glycol to a solid form, by solidifying the liquid polyethylene glycol on cooled belts or rollers and then comminuting it to a particle size of 0.1 mm to 20 mm to give flakes.

13. A process for producing a decorative material, comprising the step of converting liquid polyethylene glycol to a solid form, by processing the liquid polyethylene glycol in a cold spraying system to a particle size of 1 μm to 1000 μm to give spray powder.

14. A process for producing a decorative material, comprising the step of converting solid polyethylene glycol to powder form, by comminuting the solid polyethylene glycol by means of a grinding process to a particle size of 1 μm to 1000 μm to give ground powder.
